(19) United States
(12) Patent Application Publication
(10) Pub. No.: US 2009/0147682 A1
(43) Pub. Date: Jun. 11, 2009

(54) Bandwidth Managing Router and System

(76) Inventor: David Salick, American Fork, UT (US)

Correspondence Address: BATEMAN IP LAW GROUP, P.O. BOX 1319, SALT LAKE CITY, UT, 84110, US

(21) Appl. No.: 12/236,393

(22) Filed: Sep. 23, 2008

Related U.S. Application Data
(60) Provisional application No. 60/975,107, filed on Sep. 25, 2007.

(51) Int. Cl. H04L 12/56; G06Q 30/00

(52) U.S. Cl. 370/235; 705/34

(57) ABSTRACT

A system for managing network and internet access provides a combined router and bandwidth management unit (BMU) in communication with a client server. The client server contains account information for clients and automatically communicates with the BMU to transmit changes in access setting based on changes to the clients account status.

### PRIORITY

This application claims priority to U.S. Provisional Patent No. 60/975,107, filed Sep. 25, 2007, which in incorporated herein by reference in its entirety.

### FIELD

The present invention relates to managing data flow across a computer network. More specifically, the present invention relates to managing internet and network access with a bandwidth managing router and client server.

### BACKGROUND

Internet communication has become important in the modern world. The ability to communicate over the Internet is generally purchased from an Internet Service Provider (“ISP”) by consumers. Consumers, which may include individual persons, companies, governmental entities, etc., will typically purchase access to the internet based on a given bandwidth (speed for transmitting information) or quantity of usage per month. The ISP will provide equipment and access to communication lines to provide the customer with the agreed quantity of internet access.

The ISP desires to make sure that the customers receive the agreed upon speed or quantity of internet access. Additionally, the ISP desires to make sure that the customers pay for the internet access, and do not surpass the speed or quantity of access agreed upon in the service agreement.

It will be appreciated that many web pages are now relatively complex and a large amount of data is transmitted back and forth in viewing the web page, or completing a transaction such as purchasing products in an online store or downloading data. Many forms of internet usage, such as viewing or downloading videos, will require a user to download a large quantity of data. It will thus be appreciated how a few customers may use too many resources to the detriment of the other customers. If a single person is using a significant amount of the available bandwidth, the other users may not receive the bandwidth specified in their service agreements with the ISP.

Additionally, an ISP desires to limit access to the internet by those customers who have become delinquent in paying their bill. If a number of nonpaying customers are accessing the internet, the resources available to the paying customers is reduced.

Typically, it has been difficult for an ISP to control and adjust the access of individual users. An ISP will utilize a router to provide access to the internet. Each particular computer on a network or the internet is identified by a MAC address and an IP address. The router will transfer packets of information between a user and another computer which is hosting a website based on the MAC address and IP address of these computers. The router will receive many packets of information for many different users, and will route the packets of information to the correct computer.

As preventing individual users from consuming too much of the available bandwidth became a problem, the ISP began to use bandwidth management devices. These bandwidth managers were computers which connected to the routers and provided information to the routers about how much data (bandwidth or total usage) a particular customer was entitled to and caused the routers to stop transmitting data to the particular customer if they exceeded that limit.

It has, however, been difficult for companies to actively manage the usage of customers. For example, if a customer became delinquent in paying a bill, the accounting department of the ISP will communicate the delinquent account status to the technical department responsible for operating the routers and bandwidth managers, and the technical department will remotely log into the router and/or bandwidth manager to change the status of the MAC and IP addresses of the customer to disallow internet access. Such a process takes time and manpower, and results in delays during which the customer may continue to access the internet. Similarly, a customer who has become current on a delinquent account will experience delays as the various departments process the payment and update the status of the MAC and IP addresses associated with the customer.

There is thus a need for a more efficient method of managing internet access. There is a need for a way to more efficiently manage bandwidth and quantity access of the customers, as well as controlling access based on account status and other variables.

### SUMMARY OF THE INVENTION

It is an object of the present invention to provide an improved system for managing bandwidth and internet/network access.

According to one aspect of the present invention, a server is provided which is also capable of managing customer usage in terms of bandwidth and access. Instead of using a traditional router and bandwidth manager, a combined bandwidth management unit (BMU) and router has been developed.

According to another aspect of the present invention, the combined bandwidth manager and router (BMU) is actively connected to a client server or billing server. The billing server actively communicates with the BMU and updates the settings for each particular customer on the BMU, thus dynamically controlling that customer's access to the internet.

These and other aspects of the present invention are realized in a method and system as shown and described in the following figures and related description.

### BRIEF DESCRIPTION OF THE DRAWINGS

Various embodiments of the present invention are shown and described in reference to the drawings wherein:

FIG. 1 illustrates a functional relationship between a billing server and software (identified as PowerCode) and a router (such as an ImageStream router) in creating a combined router and bandwidth/access management unit of an embodiment of the present invention.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single FIGURE, and as such, multiple figures are presented to separately illustrate the various details of the invention in greater clarity. Similarly, not every embodiment need accomplish all advantages of the present invention.

### DETAILED DESCRIPTION

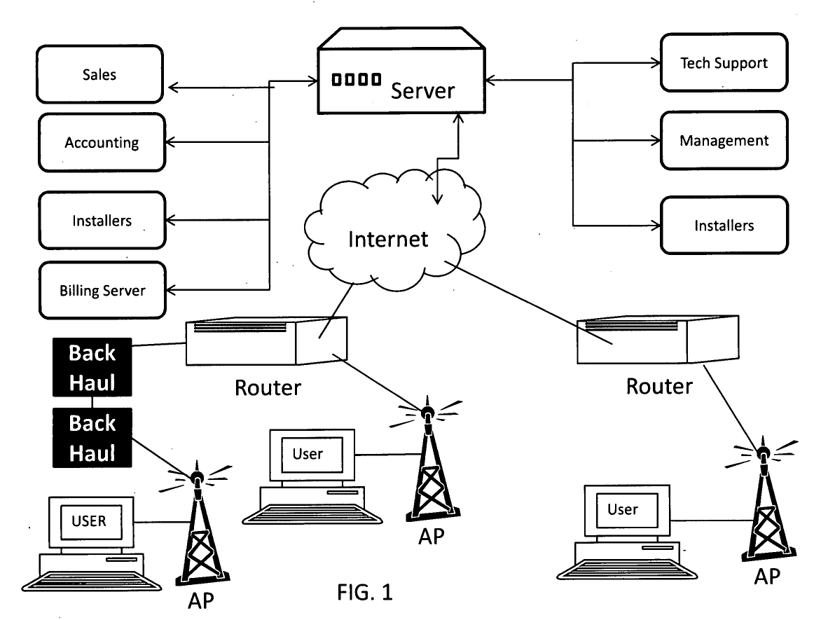

The invention will now be discussed so as to enable one skilled in the art to practice the present invention. The descriptions are exemplary of various aspects of embodiments of the invention and are not intended to narrow the scope of the appended claims. FIG. 1 illustrates functional relationships between various components that may be used or a part of embodiments described below.

According to one embodiment, a server may be provided which is also capable of managing customer usage in terms of bandwidth and access. Instead of using a traditional router and bandwidth manager, a combined bandwidth management unit (BMU) and router has been developed.

According to another embodiment, the combined bandwidth manager and router (BMU) may be actively connected to a client server or billing server. The billing server may actively communicates with the BMU and updates the settings for each particular customer on the BMU, thus dynamically controlling that customer's access to the internet.

While referred to herein as customers and discussed in terms of individual internet access, the present invention may also relate to controlling network and internet access for groups of individuals, and thus may be used to control a company network, school network, building network, as well as internet access for these groups of persons.

According to some embodiments, each particular customer may be associated with particular equipment. For example, each customer may be assigned a MAC address and IP address unique to them for the network that they are on. The billing server may then combine all of the customer information together, associating the customer with the MAC and IP addresses as well as with the accounting information for that customer, the contract information for that customer, etc.

Thus, for every customer, the billing server has information about the customer (such as name, address, telephone number), contract (such as bandwidth access and monthly usage limits, billing dates, payment due dates, and grace periods), account information (such as whether the customer is current on their bill, how much money is owed if any), and hardware information (such as the MAC address and IP address).

The billing system may use the contract and account information to determine the proper account status. If a customer has paid their bills, their account is in good status. If they have not paid a bill, but are within a grace period, their account is in good status. If they have not paid a bill and are outside of a grace period, their account is delinquent.

Based on the account status, the billing server can automatically communicate with the BMU and update the internet access settings with the BMU. Thus, if a customer's account is in good standing, the billing server will have transmitted to the BMU the internet access information for the particular customer (as typically identified by their IP address). Thus, the customer may have 1.5 MB access speed for up to 1 GB of information transmitted across the BMU. If the customer exceeds the 1 GB of information, they may be changed to an alternate access rate, such as 0.5 MB access speed.

In some embodiments, the billing server will typically review the database of customers on a daily basis to update the account status for the customer. If the customer did not pay their last bill and is out of any grace period, the billing server will automatically communicate with the BMU and will update the internet access settings for that particular customer. Thus, the customer may not be allowed to access the internet. When the customer tries to access the internet, the BMU may redirect the customer to a webpage displaying the amount due from the customer and allowing the customer to pay the amount by credit card, according to the settings transferred to the BMU by the billing server.

Once the customer has paid the balance due, the billing server may immediately process the payment, update the account status, and transmit new access settings for the customer to the BMU, allowing the customer to immediately access the internet again.

It is appreciated that a significant advantage of the present system is the ability to provide dynamic control over internet access. The billing server can track a customer's account, and can immediately provide updated internet access settings to a BMU based on the account information. The level of service provided to customers in increased in many ways. Paying customers receive an increased level of service because the BMU bandwidth is not being used by non-paying customers. Customers making a late payment receive an increased level of service as they may regain internet access immediately upon bringing their account current.

Another significant advantage of some embodiments is the ability to manage the account settings for the various customers. The billing server may maintain separate account information for every customer. The account information for each customer may be set separately, allowing different customers to have different access settings for the internet. Thus, every customer may have a unique bill amount, billing date, grace period, bandwidth level, upload/download amount, etc. Each customer may be directed towards a different webpage for accessing their account, paying for service, etc. according to the particular ISP the customer is using.

Thus, individual subscribers may have 15 days to pay a bill and a 5 day grace period while business subscribers have 45 days to pay a bill and a 30 day grace period. Government subscribers may have 60 days to pay a bill and a 60 day grace period. The account settings such as the grace period may even modified according to past payment history. Each individual subscriber may thus have different account settings determining how their internet access is handled. The billing server tracks each account, monitors changes in account status, and automatically communicates changes in internet access settings to the BMU according to the account status and information.

Thus, in some embodiments, when a new customer is added to an ISP's customer base, the customer will be added to the billing server. A service profile is created in the billing system on the server. In addition to the price of the service, the profile contains the speed of service, limits of usage, payment terms, grace periods, etc. The billing server configures the relevant router or routers to make available a pool of IP addresses than can be assigned to the customer's computer.

When the customer is added to the billing server, their computer is assigned a unique IP address from the pool of available IP addresses. This IP is reserved for use by this particular device, and can not be used by other computers or devices. All computers and internet capable devices have a unique MAC (Media Access Control) address imprinted into them. As the MAC addresses are unique across the devices of all manufacturers, the mapping of an IP address to a particular computer or internet device will uniquely identify that device.

The following commands may be sent by the central provisioning server, such as the billing server, to a remote router:

```
  1)  reserve an IP
      this instructions set to set to the DHCP (Dynamic Host Configuration Protocol) server
      running to the router.
          host ip-172.16.3.10 {
            hardware ethernet 00:C0:9F:90:0F:EB;
            fixed-address 172.16.3.10;
          }
        In this example the device with a MAC address of 00:C0:9F:90:0F:EB has the IP
        address 172.16.3.10 reserved
  2)  permit access to the network
        sbin/iptables -t nat -I powernoc-out-subnet5 -s 172.16.3.10 -j ACCEPT
        sbin/iptables -t nat -I powernoc-in-subnet5 -d 172.16.3.10 -j ACCEPT
    The above two commands instruct the firewall utility (iptables) to permit internet access
to and from the IP 172.16.3.10.
  3)  provisioning bandwith
        sbin/iptables -t mangle -I powernoc-out-subnet5 -s 172.16.3.10 -j MARK --set-
        mark 0x2
        sbin/iptables -t mangle -I powernoc-in-subnet5 -d 172.16.3.10 -j MARK --set-
        mark 0x2
    The first step marks packets that originate from and are destined for 172.16.3.10 with a
    unique mark. In the example above the Billing server has assigned the mark 0x2
    (hexadecimal notation).
    The billing server then sends the commands below to specifically provision bandwidth
    parameters for the customer with IP address 172.16.3.10 and using the hardware device
    with the MAC of 00:C0:9F:90:0F:EB
    a)  /sbin/tc class replace dev eth0 parent 1:1 classid 1:2 htb rate 1234 Kbit ceil
    1555 Kbit burst 8k
    b)  sbin/tc class replace dev eth5 parent 1:1 classid 1:2 htb rate 999 Kbit ceil 1900 Kbit
    burst 8k
    Command a) specifies that packets with the mark 0x2 (classid 1:2) will be able to upload
    at a rate of 1234 Kilo bits per second (Kbits/sec) and may burst up to 1555 Kbits/sec of
    upload speed. In this case the router's external interface is eth0 while the internal
    interface is eth5. The next command specifies that packs with the mark 0x2 can
    download at a speed of 999 Kbits/sec and may burst to download speeds of 1900 Kbits/sec.
```

By sending the router commands which may be specific for a particular customer, the billing server may be able to convert the router into a combined router and bandwidth/access management unit (BMU). The router is presented with updated information about how the particular customer may access the internet, including access speed or download limits, limiting access due to not paying the bill, etc. as discussed herein.

The BMU and billing server may also aid in managing filtering of internet content for the customers. If a customer pays for an internet filtering service, their account information on the billing server may be updated to indicate the filtering service, and would indicate the proxy server used to filter the content. This proxy server information would be automatically transmitted to the BMU which handles that customer's internet access. Then, when the customer requests information from a webpage, the request is sent to the proxy server to determine if the website content is allowed, and if it is allowed the BMU will transfer the requested information.

In addition to the internet access scenarios described above, the same system of a billing server, customer account information, and BMU may be used to manage internet and network access for a school, company, building, etc. Each computer in a company or network will communicate through a router, which may be replaced by a BMU. The BMU may be connected to and in communication with an account server as described above. While the individual employees in a company may not pay for access, there may still be a need to control the access.

For example, certain persons such as management personnel, may require a higher bandwidth than most employees. A billing server may be used to store the internet and network access settings for each particular computer, store any changes in access settings based on events, and constantly transmit any changes in access settings to the BMU which is routing information between the computers and managing the bandwidth used by the computers. The use of the billing server allows the network manager to easily and quickly change the access settings for any of the various computers in order to utilize network resources more efficiently.

There is thus disclosed an improved system for managing internet and network access. It will be appreciated that numerous changes may be made to the present invention without departing from the scope of the claims.

What is claimed is:

1. A system for managing access to a network or the internet comprising:
a bandwidth management unit comprising a computer configured for routing and transmitting data between computers and configured for managing the bandwidth used by said computers;
a client server comprising a database of customer information including information about access settings for each customer and including information about how the access settings change for each particular customer based on usage and based on account status; and
wherein the client server is in communication with the bandwidth management unit and wherein the client server automatically transmits account settings for each particular customer to the bandwidth management unit based on changes to the particular customer's account status.

2. The system of claim 1, wherein the client server automatically prevents internet access for a customer if that customer fails to pay their bill.

3. The system of claim 2, wherein, if the customer attempts to access the internet without paying their bill, the system redirects the customer to a webpage where the customer may pay their bill.

4. The system of claim 3, wherein, upon paying their bill, the client server automatically communicates with the bandwidth management unit to allow the customer to access the internet.
